(19) United States
(12) Patent Application Publication
(10) Pub. No.: US 2026/0008447 A1
(43) Pub. Date: Jan. 8, 2026

(54) METHOD FOR OPERATING A PISTON PUMP IN BRAKE SYSTEMS WITHOUT SUCTION THROTTLING

(71) Applicant: Continental Automotive Technologies GmbH, Hannover (DE)

(72) Inventors: Andreas Neu, Kuhardt (DE); Andreas Top, Bocholt (DE); Michael Stein, Idstein (DE)

(73) Assignee: Continental Automotive Technologies GmbH, Hannover (DE)

(21) Appl. No.: 18/993,532

(22) PCT Filed: Jun. 23, 2023
(86) PCT No.: PCT/DE2023/200127

§ 371 Date: Jan. 11, 2025

(30) Foreign Application Priority Data
Jul. 11, 2022 (DE) 10 2022 207 083.6

(51) Int. Cl. B60T 13/74; B60T 8/171; B60T 8/172; B60T 17/22

(52) U.S. Cl. CPC B60T 13/745; B60T 8/171; B60T 8/172; B60T 17/22; B60T 2270/402; B60T 2270/413

(57) ABSTRACT

A method for controlling a hydraulic brake system having at least one pressure supply device for conveying brake fluid into at least one wheel brake is disclosed. A required brake fluid volume is determined for setting a target pressure in the at least one wheel brake and the pressure supply device is actuated to convey the brake fluid volume. In order to set the target pressure quickly and accurately, a ramp-down behavior of the pressure supply device is observed by determining a threshold rotating speed which, when the motor of the pressure supply device is switched off, conveys a follow-up volume corresponding to the required brake fluid volume, and the rotating speed of the pressure supply device is limited to the threshold rotating speed, or the threshold rotating speed is requested by the pressure supply device.

### TECHNICAL FIELD

A method for controlling a hydraulic brake system having at least one pressure supply device for conveying brake fluid into at least one wheel brake is disclosed. A brake system is also disclosed.

### BACKGROUND

Brake systems have long been known to be able to build up a brake pressure by means of the pressure supply device, independently of the driver. In most cases, a target pressure is to be achieved quickly, for which purpose large volumetric flows and thus rotating speeds of the motors of the pressure supply device are required. However, since these rotating speeds do not abruptly drop to zero, brake fluid is pumped even after the target pressure has been reached, thus conveying a follow-up volume. This can lead to a large overshoot of the pressure and thus to excessive braking.

### SUMMARY

It is therefore the object to provide a method for such brake systems, which avoids overshoot.

The object is achieved in that a ramp-down behavior of the pressure supply device is observed when setting the pressure. For this purpose, a threshold rotating speed is calculated, which, when the motor of the pressure supply device is switched off, would convey a follow-up volume corresponding to the required brake fluid volume. This means that when the pressure supply device runs at the threshold rotating speed and is switched off, the required brake fluid volume is still pumped into its afterflow. The determined threshold rotating speed is specified to the pressure supply device as a limit, or the threshold rotating speed is simply requested directly by the pressure supply device. This means that the requirement of a rotating speed can be extended by a limitation of this type, and only the limited rotating speed requirement can be requested by the pressure supply device. Alternatively, the threshold rotating speed determined is requested directly. This generally at the beginning exceeds the range of rotating speeds that can be physically achieved by the pressure supply device in the first place. Thus, the pressure supply device runs at its maximum rotating speed or the maximum permissible rotating speed. Only when the actual pressure approaches the target pressure and thus the required volume of brake fluid still to be conveyed decreases, the threshold rotating speed drops to a range that limits the actual rotating speed of the pressure supply device. This means that the pump stops running after being switched off, and the target pressure is precisely achieved by the pressure supply device which continues to run.

In an embodiment, the pressure supply device is a piston pump. Such a pump can convey high volumetric flows and achieves high end pressures at manageable component costs. By combining such a pump with the method, a target pressure can thus be achieved quickly and accurately.

In another embodiment, the brake system is a redundant brake system with an additional second pressure supply device, in particular a linear actuator. Such redundant brake systems can be used for highly automated driving, where the driver is the last fallback level to fail.

In another embodiment, the piston pump has no suction throttling, for example no switchable valve on a suction side, and for example is directly connected to a non-pressurized brake fluid reservoir. This means that the cost of this additional component can be dispensed with, and overshooting of the pressure is nevertheless prevented.

In another embodiment, in the determination of the threshold rotating speed, a pressure difference prevailing at the pressure supply device is observed, in particular by using a ramp-down characteristic curve, which specifies a rotating speed gradient and/or a ramp-down time for a given pressure. In general, the greater the counter pressure, the shorter the ramp-down time. In an alternative embodiment, other characteristic curves or maps can also be used, which in each case correlate the follow-up volume at the current rotating speed of the pump and the prevailing pressure, so that the threshold rotating speed can be determined for a given state of the brake system.

Analytical analysis according to the energy conservation law shows that friction can also be added to the determination:

$$\frac{1}{2} ⋆ J ⋆ {ω}^{2} = R ⋆ N + {\int }_{{P}_{1}}^{{P}_{2}} d V \approx P ⋆ V = R ⋆ N + P ⋆ \frac{N}{a}$$

J: Motor mass moment of inertia
ω: Circular frequency/rotating speed of the motor
P₁, P₂, P: Pressure
R: Coefficient of friction
N: Number of revolutions
a: Volume per revolution

Resolving this equation by the number of revolutions N and comparing it with the solution found experimentally and listed below:

$$N = \frac{\frac{1}{2} ⋆ J ⋆ {ω}^{2}}{P / a + R} = \frac{{n}^{2}}{2 ⋆ ( {p}_{1} ⋆ P + {p}_{2} )}$$

n: Rotating speed
p1: Parameter 1
p2: Parameter 2
in particular, the square speed dependency is demonstrated. The parameters p1 and p2 can therefore be determined either experimentally or by means of the variables of the analytical analysis.

In another embodiment, the voltage supply of the motor of the pressure supply device is short-circuited when the motor is switched off. This leads to a decelerating electromagnetic force via induction and thus to a faster ramp-down of the pump. This results in a lower replenishment volume for a given speed and differential pressure over the pump. The pump can therefore be operated at high rotating speed for longer, which means that the target pressure or target volume can be reached faster without pressure overshooting.

In another embodiment, the required brake fluid volume is determined from a pressure/volume characteristic curve. This makes it particularly easy to establish a correlation between the target pressure and the required brake fluid volume.

In another embodiment, as soon as the actual rotating speed of the pressure supply device is greater than or equal to the threshold rotating speed, the target rotating speed of the pressure supply device is set to zero. This also reduces the electrical output supplied to the pump to zero, and the latter will run out. As a result of the method, the target pressure is thus set precisely without continuing the supply of a current to the motor.

The object is moreover achieved by a hydraulic motor vehicle brake system having at least one pressure supply device and a control unit for feedback-controlling the pressure supply device, wherein the control unit is specified to carry out a preceding method.

The object is also achieved by a computer program product which is designed in such a manner that the latter, when executed in a control device, carries out one of the methods.

The object is moreover achieved by a data carrier signal that transmits such a computer program product.

A redundant brake system having a plurality of pressure or volume sources: A linear actuator (LAC) and a piston pump.

### BRIEF DESCRIPTION OF THE DRAWINGS

Further features and potential applications are also derived from the description hereunder of exemplary embodiments and from the drawings. All of the features described and/or pictorially depicted are associated with the subject matter of the embodiments both individually and in any combination, also independently of their combination in the claims or the back-references thereof.

FIG. 1 schematically shows a brake system,

FIG. 2 shows a diagram with an exemplary ramp-down characteristic curve.

### DETAILED DESCRIPTION

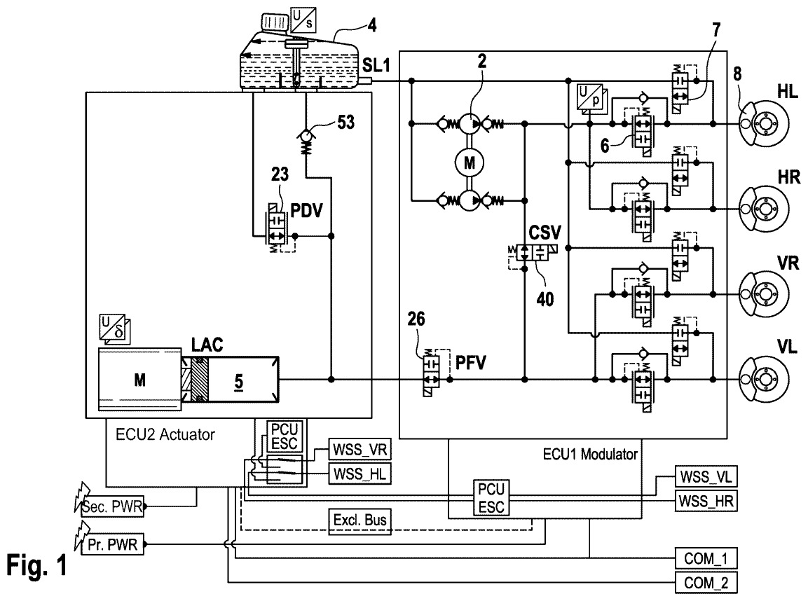

Illustrated in FIG. 1 is a redundant hydraulic brake system for motor vehicles. According to the example, the brake system is designed for actuating four hydraulically actuatable wheel brakes 8; an upgrade to more wheel brakes is easily possible. According to the example, the wheel brakes (HL, HR) are assigned to the rear axle and the wheel brakes (VL, VR) are assigned to the front axle of the vehicle.

The brake system comprises a first assembly, which is configured according to the example as a first electro-hydraulic brake control unit having a valve block and a first electronic control device, and a second assembly which is configured according to the example as a second electro-hydraulic brake control unit having a valve block and a second electronic control device.

Disposed on the first assembly is a pressure medium reservoir 4 with three chambers, wherein the first chamber is assigned a first vessel port, the second chamber is assigned a second vessel port, and the third chamber is assigned a third vessel port.

A first electrically actuatable pressure source 5 is disposed in the first assembly.

Disposed in the second assembly are a second electrically actuatable pressure source 2 and wheel-specific brake pressure modulation valves which are embodied as an electrically actuatable inlet valve 6 and an electrically actuatable outlet valve 7 for each wheel brake 8.

The first pressure source 5 and the second pressure source 2 are connected on the pressure side to a brake supply line, the four inlet valves 6 being connected to the latter. All four wheel brakes 8 can thus be actuated by means of the first pressure source 5 or by means of the second pressure source 2.

Disposed in the brake supply line is an electrically actuable circuit isolating valve 40, and therefore, when the circuit isolating valve 40 is closed, the brake supply line is divided into a first line portion, to which the inlet valves 6 and/or the wheel brakes 8 of the rear axle are connected, and a second line portion, to which the inlet valves 6 and/or the wheel brakes 8 of the front axle are connected. The second pressure source 2 is hydraulically connected to the first line portion, and the first pressure source 5 is hydraulically connected to the second line portion. When the circuit isolating valve 40 is closed, the brake system is thus separated or divided into two hydraulic brake circuits I and II. Here, in the first brake circuit I, the pressure source 2 is still connected to only the wheel brakes 8 of the rear axle (via the first line portion) and, in the second brake circuit II, the first pressure source 5 is still connected to only the wheel brakes 8 of the front axle (via the second line portion). The circuit isolating valve 40 is embodied to be normally open when non-energized.

As already mentioned, the brake system comprises, for each hydraulically actuable wheel brake 8, an inlet valve 6 and an outlet valve 7 which are hydraulically interconnected in pairs via central ports and are each connected to a hydraulic wheel port of the second assembly, to which the corresponding wheel brake 8 is connected. A check valve which opens in the direction of the brake supply line is connected in parallel with each of the inlet valves 6. The output ports of the outlet valves 7 are connected to the pressure medium reservoir 4, or the second chamber thereof, via a common return line. The input ports of all inlet valves 6 can be supplied by means of the brake supply line (that is to say when the circuit isolating valve 40 is open) with a pressure which is provided by the first pressure source 5 or, for example in the event of a failure of the first pressure source 5, by the second pressure source 2.

The first electrically controllable pressure source 5 of the valve block is designed as a hydraulic cylinder-piston arrangement (or a single-circuit electro-hydraulic actuator (linear actuator)), the piston of which can be actuated, for example advanced and retracted, in order to build up and dissipate a pressure in a pressure chamber, by a schematically indicated electric motor with the intervention of a likewise schematically illustrated rotary-translatory gear mechanism. The piston delimits the pressure chamber of the pressure source 5. A rotor position sensor, which detects the rotor position of the electric motor and which is indicated merely schematically, is provided for actuating the electric motor.

A system pressure line portion is connected to the pressure chamber of the first electrically controllable pressure source 5. By means of the line portion, the pressure source 5, or the pressure chamber thereof, is connected to a hydraulic port of the first assembly, which hydraulic port is connected via a hydraulic connecting element to a hydraulic port of the second assembly. This connection represents the only hydraulic pressure connection, in particular the only hydraulic connection, between the first and the second assembly. This is a hydraulic connection for transmitting a brake pressure for actuating the wheel brakes 8.

The pressure chamber is connected via a (replenishment) line to the pressure medium reservoir 4, irrespective of the activated state of the piston. Disposed in the line is a check valve 53, which connects to the second chamber and is closed in the direction of the pressure medium reservoir 4. An electrically switchable valve 23 forms a further connection to the first tank chamber, which is also and jointly connected to the output connection of the linear actuator 5. The cylinder-piston arrangement 5 does not have any snifter bores, for example.

The second electrically controllable pressure source 2 of the second assembly is designed, for example, as a dual-piston pump, the two pressure sides of which are interconnected. The suction sides are connected to the return line and thus to the pressure medium reservoir 4. The pressure sides are connected to the first line portion of the brake supply line.

According to the example, an electrically actuable, normally open when non-energized, isolating valve 26 is disposed in the second assembly, in addition to the pressure source 2 and the brake pressure modulation valves 6, 7. The isolating valve 26 is hydraulically disposed between the port and the second line portion of the brake supply line. Thus, the first pressure source 5 is separably connected to the second line portion, or the brake supply line, via the isolating valve 26.

According to the example, the brake system comprises in the brake circuit I a pressure sensor which is thus assigned to the second pressure source 2. This is for protection against bursting when the circuit is divided, that is to say when the circuit isolating valve 40 is closed. However, the pressure sensor can also be disposed in the brake circuit II, or a second pressure sensor can be provided in such a way that each of the two brake circuits I and II can be directly monitored by means of a pressure sensor.

According to the example, the brake system comprises, for leakage monitoring purposes, a level-measuring device for determining a pressure medium level in the pressure medium reservoir 4.

An electronic control device is assigned to each valve block. Each electronic control device comprises electrical and/or electronic elements (for example, microcontrollers, power modules, valve drivers, other electronic components, etc.) for actuating the electrically actuable components of the associated valve block, and optionally the assigned sensors. The valve block and electronic control device are embodied in a known manner as an electro-hydraulic unit.

The first electronic control device actuates the first pressure source 5. According to the example, the first pressure source 5 is supplied with energy (from a first electrical energy source) via the first electronic control device.

The second electronic control device actuates the second pressure source 2. According to the example, the second pressure source 2 is supplied with energy (from a second electrical energy source) via the second electronic control device.

According to the example, the first pressure source 5 can be or is actuated exclusively by the first electronic control device, and the second pressure source 2 can be or is actuated exclusively by the second electronic control device.

The brake system has a primary pressure source 5 and a secondary pressure source 2, each of which being electrically operated by an ECU and having a suction port and a pressure port. No brake fluid can flow into the pressure port of the secondary pressure source 2 even in the electrically non-energized state. The primary pressure source 5 may be a linear actuator with a replenishment check valve 53 and the secondary pressure source 2 is a piston pump. The secondary pressure source 2 can preferably generate a higher pressure than the primary pressure source 5.

The suction sides of the two pressure sources 2, 5 are connected to a pressure medium reservoir 4, preferably in each case to at least one of the separate chambers.

The pressure side of the primary pressure source 5 is connected to a primary circuit node via an electromagnetic valve 26, also called pressure switch-on valve or isolating valve.

The pressure side of the secondary pressure source 2 is connected directly (without an intervening valve) to a secondary circuit node. The two circuit nodes are connected to one another via an electromagnetic valve 40, also referred to as a circuit isolating valve.

In normal operation, the pressure in the wheel brakes is built up by the primary pressure source 5. The pressure to the primary pressure source 5 is reduced. The pressure is modulated by the inlet and outlet valves wheel-specifically as required. If necessary, the isolating valve 26 is closed so that the primary pressure source 5 can induct additional volume.

If a particularly high volume flow rate is requested, both pressure sources 5 and 2 operate simultaneously in parallel. If a particularly high pressure is requested, the isolating valve 26 is closed and the secondary pressure source 2 increases the pressure beyond the pressure of the primary pressure source 5. Outside of braking operations, atmospheric pressure equalization can be permanently ensured via the isolating valve 23 and the isolating valve 26.

In the event of a leak in the brake system, the circuit isolating valve 40 is closed and the system is thus divided into two independent brake circuits I and II.

The isolating valve 26 is preferably actuated by the secondary ECU. The following description of operation in the event of a fault refers to this valve assignment.

If the primary system, in particular the primary ECU or the voltage supply thereof, fails electrically, the secondary ECU closes the isolating valve 26 to build up pressure via the secondary pressure source 2. Pressure is dissipated via the isolating valve 26 or via the outlet valves 7. The inlet and outlet valves are preferably actuated by the secondary ECU in such a way that the pressure can be modulated wheel-specifically.

If the secondary system, in particular the secondary ECU or the voltage source thereof, fails electrically, the pressure is built up and dissipated by way of the primary pressure source 5 as in normal operation. Wheel-specific pressure control has to be dispensed with, but joint modulation of the wheel pressures remains possible in order to prevent the vehicle being destabilized by locking wheels.

In the above operating modes, the piston pump 2 is therefore the pressure source for at least two wheel brakes. In this instance, the pressure side of the pump 2, in addition to the inlet valves 6 of the wheel brakes 8, is partially only connected to a closed valve, i.e. the circuit isolating valve 40 or switch-on valve 26.

A wheel pressure regulator (WPC) can keep a higher pilot pressure away from the wheel by closing the inlet valve. In this case, however, the pump pumps counter to a hydraulically rigid space, which can lead to high pressure peaks and thus damage to the hydraulic components.

The pump should therefore be actuated in such a way that a target pressure is set quickly and without overshoot. The difficulty here is that the pump conveys fluid when the motor is rotating and cannot be throttled at the suction side.

In one method, on the one hand, the motor is decelerated electrically as soon as the target pressure is almost reached. This takes place by separating the motor from the supply voltage by means of the electronic power driver modules and short-circuiting the motor, thus allowing braking torque to be generated by the current generated via the generator's own voltage and the induced magnetic field.

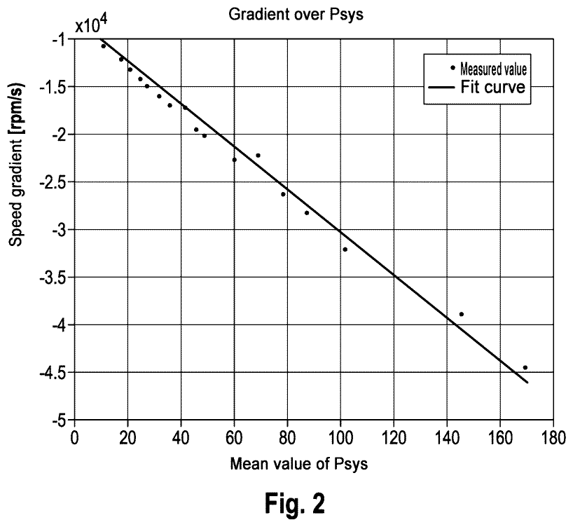

A ramp-down characteristic curve is furthermore determined. This means that the correlation between the counter pressure and the gradient is determined with regard to the rotating speed that is set during ramp-down. This characteristic curve can be learnt once in advance and stored in a brake system. Alternatively or additionally, the characteristic curve can be learnt and/or adjusted during operation by measuring the pump's ramp-down behavior. Such a characteristic curve is illustrated in FIG. 2.

With this knowledge, conclusions pertaining to the ramp-down time T can be drawn in normal operation. The gradient G is formed by the parameters p1 and p2 (both <0) of the interpolation and the pressure P (=Psys):

$$G = {p}_{1} ⋆ P + {p}_{2}$$

Since in the exemplary brake system of FIG. 1 the suction side of the pump is connected to the non-pressurized vessel, the system pressure on the pressure side of the pump corresponds to the pressure difference via the pump.

The ramp-down time T, from the current rotating speed n, and the gradient G.

$${N}_{t} = \frac{n ⋆ T}{2} = − \frac{n ⋆ \frac{n}{{p}_{1} ⋆ P + {p}_{2}}}{2} = \frac{{n}^{2}}{2 ⋆ ( {p}_{1} ⋆ P + {p}_{2} )}$$

And thus the follow-up volume V, which is still conveyed by these N revolutions:

$$V = α ⋆ N$$

For pressure control, the given volume requirement is determined to satisfy the pressure requirement using the known pressure/volume characteristic curve. This can be used to determine a threshold rotating speed n*, which, if set, precisely sets the target pressure without overshoot in the ramp-down.

$${n}^{⋆} = \sqrt{− 2 ⋆ ( {p}_{1} ⋆ P + {p}_{2} ) ⋆ \frac{V ( P )}{α}}$$

Where p1<0, p2<0

This threshold rotating speed can then be used either as a parameter or as a restriction for the hydraulic pump.

In the case of operation with the LAC, this method can also be applied by the regulator, in that the latter for the LAC simply requests the volume requirement, which the piston pump is supposed to contribute, in addition to the target pressure.

As the pressure continues to increase when the pump ramps down, there are various counter pressures at the piston pump, which have a corresponding effect on the ramp-down behavior. Assuming a linear ramp-down characteristic curve as shown in FIG. 2, this can simply be taken into account by taking the current actual pressure and the target pressure and forming a sum therefrom, which may also be weighted:

$${P}_{W S} = \frac{b ⋆ {P}_{actual} + c ⋆ {P}_{target}}{b + c}$$

Where b+c=1

In a variant, the motor controller can first be specified a rotating speed corresponding to the volume requirement. If the ramp-down speed n* is less than nVol or the actual rotating speed nActual, the target rotating speed is set to 0 and the motor sets the desired pressure during its ramp-down or stopping operation.

It is thus possible by the method without additional hardware to set a pressure without overshoot.

1. A method for controlling a hydraulic brake system comprising:
determining a required brake fluid volume for setting a target pressure in the at least one wheel brake;
actuating a pressure supply device to convey the required brake fluid volume; by determining a threshold rotating speed, wherein a ramp-down behavior of the pressure supply device is observed;
conveying a follow-up volume corresponding to the required brake fluid volume when a motor of the pressure supply device is switched off, and
one of limiting the rotating speed of the pressure supply device to the threshold rotating speed and requesting the threshold rotating speed by the pressure supply device.

2. The method as claimed in claim 1, wherein the pressure supply device is a piston pump.

3. The method as claimed in claim 2, wherein the brake system is a redundant brake system with an additional second pressure supply device.

4. The method as claimed in claim 2, wherein the piston pump has no suction throttling and is directly connected to a non-pressurized brake fluid reservoir.

5. The method as claimed in claim 1, further comprising observing a pressure difference prevailing at the pressure supply device in the determination of the threshold rotating speed.

6. The method as claimed in claim 1, wherein voltage supply inputs of the motor of the pressure supply device are short-circuited when the motor is switched off.

7. The method as claimed in claim 1, wherein the required brake fluid volume is determined from a pressure/volume characteristic curve.

8. The method as claimed in claim 1, further comprising setting the target rotating speed of the pressure supply device to zero as soon as the actual rotating speed of the pressure supply device is greater than or equal to the threshold rotating speed.

9. A hydraulic motor vehicle brake system comprising:
at least one pressure supply device; and
a control unit for feedback-controlling the pressure supply device, wherein the control unit has instructions for:
determining a required brake fluid volume for setting a target pressure in the at least one wheel brake;
actuating a pressure supply device to convey the required brake fluid volume by determining a threshold rotating speed, wherein a ramp-down behavior of the pressure supply device is observed;
conveying a follow-up volume corresponding to the required brake fluid volume when a motor of the pressure supply device is switched off, and
one of limiting the rotating speed of the pressure supply device to the threshold rotating speed and requesting the threshold rotating speed by the pressure supply device.

10. A computer program product which is designed in such that when executed in a control device, carries out instructions for:
determining a required brake fluid volume for setting a target pressure in the at least one wheel brake;
actuating a pressure supply device to convey the required brake fluid volume by determining a threshold rotating speed, wherein a ramp-down behavior of the pressure supply device is observed;
conveying a follow-up volume corresponding to the required brake fluid volume when a motor of the pressure supply device is switched off, and
one of limiting the rotating speed of the pressure supply device to the threshold rotating speed and requesting the threshold rotating speed by the pressure supply device.

11. The computer program product as claimed in claim 10, wherein the instructions are transmitted via a data carrier signal.

12. The method as claimed in claim 3, wherein the additional second pressure supply device is a linear actuator.

13. The method as claimed in claim 5, further comprising using a ramp-down characteristic curve, which specifies at least one of a rotating speed gradient and a ramp-down time for a given pressure difference.
